(19) United States
(12) Patent Application Publication
(10) Pub. No.: US 2016/0125734 A1
(43) Pub. Date: May 5, 2016

(54) METHOD AND APPARATUS FOR DETERMINING ROAD NETWORK LANE DIRECTIONAL CHANGES

(71) Applicant: HERE Global B.V., Veldhoven (NL)

(72) Inventor: Leon Oliver Stenneth, Chicago, IL (US)

(21) Appl. No.: 14/532,629

(22) Filed: Nov. 4, 2014

(51) Int. Cl. G08G 1/056

(52) U.S. Cl. CPC G08G 1/056

(57) ABSTRACT

A method, apparatus and computer program product are provided for determining road network lane directional changes. In the context of a method, the method includes receiving traffic data for a predetermined period of time, mapping the traffic data to a road network to create a traffic data map, determining a direction of travel for one or more road network lanes based on the traffic data map, and determining, using a processor, if the one or more road network lanes change direction based on the direction of travel over the predetermined period of time.

### TECHNOLOGICAL FIELD

An example embodiment of the present invention relates to traffic information technology and, more particularly, to a method, apparatus and computer program product for determining road network lane directional changes.

### BACKGROUND

A reversible lane is a traffic lane which may change direction depending on specified conditions, such as traffic density. For example, certain traffic lanes may allow traffic to flow toward a city center or event location during a morning rush hour or prior to an event, and reverse direction, allowing traffic to flow away from the city center or event location, during the afternoon rush hour or after the event. These reversible lanes are common in metropolitan areas and other places which experience large traffic ebbs and flows, such as the Kennedy expressway in Chicago.

Reversible lanes may also be commonly found in tunnels, bridges and surrounding roadways, even in locations in which the lanes are not regularly reversed to handle traffic flow. The presence of reversible lanes in these locations allows authorities to close or reverse lanes in unusual circumstances, such as construction or a traffic accident, may be aided by altering traffic flow with more or fewer lanes.

One drawback of reversible lanes is the changes to the traffic pattern are not conventionally detected or determined by traffic providers, e.g. services which identify traffic congestion, and in some cases provide alternate routes. This could result in a traffic provider supplying detrimental directions to drivers, for example routing a driver in the wrong direction on a reversible lane, or not identifying a better, e.g. more expeditious, route due to a change in the reversible lane direction.

### BRIEF SUMMARY

A method, apparatus and computer program product are provided in accordance with an example embodiment for determining road network lane directional changes. In an example embodiment, a method is provided that includes receiving traffic data for a predetermined period of time, mapping the traffic data to a road network to create a traffic data map, determining a direction of travel for one or more road network lanes based on the traffic data map, and determining, using a processor, if the one or more road network lanes changes direction based on the direction of travel over the predetermined period of time.

In an example embodiment, the method also includes suppressing outlier traffic data. In some example embodiments of the method, suppressing outlier traffic data further includes comparing the traffic data to a predetermined threshold and suppressing traffic data which satisfies the predetermined threshold. In some example embodiments, the method also includes determining a mode of transportation associated with the traffic data and suppressing traffic data associated with a predetermined mode of transportation.

In some example embodiments, the method also includes determining the times at which the one or more road network lanes change direction. In an example embodiment of the method, the traffic data includes location data, direction data, speed data, and time data. In some example embodiments, the method also includes clustering the mapped traffic data based on timestamps into a plurality of time intervals and then determining if one or more road network lanes change direction further based on the clustered mapped traffic data.

In another example embodiment, an apparatus is provided including at least one processor and at least one memory including computer program code with the at least one memory and computer program code configured to, with the processor, cause the apparatus to at least receive traffic data for a predetermined period of time, map the traffic data to a road network to create a traffic data map, determine a direction of travel for one or more road network lanes based on the traffic data map, and determine if the one or more road network lanes changes direction based on the direction of travel over the predetermined period of time.

In some example embodiments, the at least one memory and the computer program code, of the apparatus, are further configured to suppress outlier traffic data. In an example embodiment of the apparatus, suppressing outlier traffic data further includes comparing the traffic data to a predetermined threshold and suppressing traffic data which satisfies the predetermined threshold. In an example embodiment of the apparatus, the at least one memory and the computer program code are further configured to determine a mode of transportation associated with the traffic data and to suppress traffic data associated with a predetermined mode of transportation.

In an example embodiment of the apparatus, the at least one memory and the computer program code are further configured to determine the times at which the one or more road network lanes change direction. In some example embodiments of the apparatus, the traffic data includes location data, direction data, speed data, and time data. In an example embodiment, the at least one memory and the computer program code of the apparatus are further configured to cluster the mapped traffic data based on timestamps into a plurality of time intervals; and then to determine if one or more road network lanes change direction further based on the clustered mapped traffic data.

In a further example embodiment, a computer program product is provided including at least one non-transitory computer-readable storage medium having computer-executable program code portions stored therein with the computer-executable program code portions comprising program code instructions configured to receive traffic data for a predetermined period of time, map the traffic data to a road network to create a traffic data map, determine a direction of travel for one or more road network lanes based on the traffic data map, and determine if the one or more road network lanes change direction based on the direction of travel over the predetermined period of time.

In an example embodiment of the computer program product, the computer-executable program code portions further comprise program code instructions configured to suppress outlier traffic data. In some example embodiments of the computer program product, suppressing outlier traffic data further includes comparing the traffic data to a predetermined threshold and suppressing traffic data which satisfies the predetermined threshold. In an example embodiment of the computer program product, the computer-executable program code portions further comprise program code instructions configured to determine a mode of transportation associated with the traffic data and to suppress traffic data associated with a predetermined mode of transportation.

In an example embodiment, the computer-executable program code portions, of the computer program product, further comprise program code instructions configured to determine the times at which the one or more road network lanes change direction. In some example embodiments of the computer program product, the computer-executable program code portions further comprise program code instructions configured to cluster the mapped traffic data based on timestamps into a plurality of time intervals and then to determine if one or more road network lanes changes direction further based on the clustered mapped traffic data.

In yet another example embodiment, an apparatus is provided that includes means for receiving traffic data for a predetermined period of time, means for mapping the traffic data to a road network to create a traffic data map, means for determining a direction of travel for one or more road network lanes based on the traffic data map, and means for determining if the one or more road network lanes change direction based on the direction of travel over the predetermined period of time.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a communications diagram in accordance with an example embodiment of the present invention;

FIG. 2 is a block diagram of an apparatus that may be specifically configured for determining road network lane directional changes in accordance with an example embodiment of the present invention;

FIG. 3 illustrates a photograph of an example reversible traffic lane;

FIGS. 4 and 5 illustrate an example mapped traffic data over a predetermined period of time in accordance with an example embodiment of the present invention; and

FIG. 6 a flow chart illustrating the operations performed, such as by the apparatus of FIG. 2, in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), can be differentiated from a “computer-readable transmission medium,” which refers to an electromagnetic signal.

### Overview

Reversible lanes may be determined by analysis of real time or near real time and historical traffic data. Traffic data may include location, speed, direction, vehicle identifier, time, or the like. The traffic data may be received by a traffic server from a database and/or from traffic reporting devices in vehicles or associated with a road network.

The traffic data may be mapped to a road network based on location data to create a traffic data map. The traffic server may determine the direction of travel for one or more lanes based on the mapped traffic data, such as direction data, at multiple location and time data points for one or more vehicles, or the like. The traffic server may determine if any of the road network lanes change direction based on changes in the direction of travel in a particular road network lane over time.

In some example embodiments the traffic server may suppress, or disregard, traffic data outliers, such as unrealistic directions, speeds, sequence of locations, or outliers resulting from GPS inaccuracies. In an example embodiment the traffic server may also suppress traffic data of specified modes of transport, for example busses, transport trucks, bikes, or the like. These modes of transport may skew traffic data due to their use of dedicated lanes, or irregular traffic flow, e.g. against the normal traffic pattern flow, or the like.

In instances in which the reversible lane changes direction on a regular interval, the traffic server may determine the timing of the change in road network lane direction, such as the time at which rush hour lanes switch directions.

The reversible lane data that defines the direction of a lane of traffic at various points in time may be used to generate more accurate routing instructions for users. In an instance in which the traffic data is real time or near real time, the reversible lane data may allow the generation of real time updates to routes to avoid traffic buildup and/or shift to more expeditious routes.

### Communications Diagram

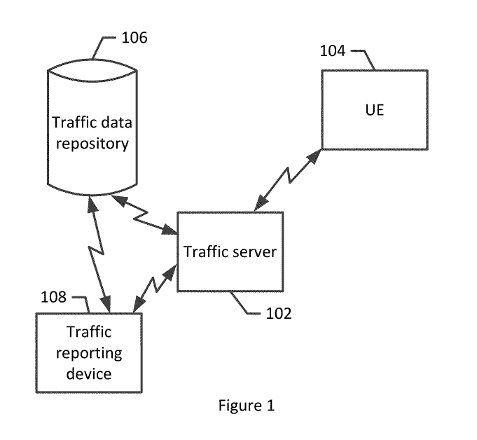

A method, apparatus and computer program product are provided in accordance with an example embodiment for determining road network lane directional changes. FIG. 1 illustrates a communication diagram including user equipment (UE) 104, in data communications with traffic server 102. The traffic server 106 may include a traffic data repository 106, such as a local traffic data memory, or be associated with the traffic data repository, such as a remote traffic data server. The UE 104 may be a mobile computing device, such as a laptop computer, tablet computer, mobile phone, smart phone, navigation unit, personal data assistant, or any other mobile device configured to for navigational services. Additionally or alternatively the UE 104 may be a fixed computing device, such as a personal computer, computer workstation, kiosk, office terminal computer or system, or the like. The traffic server 102 may be one or more fixed or mobile computing devices. The traffic server may be in data communication with the traffic data repository 106 and/or one or more traffic reporting devices 108.

The traffic reporting devices 108 may be mobile computing devices, vehicle computing devices, or any other mobile device carried, for example, by a vehicle and configured to measure or determine location, speed, time, direction, or the like associated with traffic over a road network. In some example embodiments the traffic reporting device traverses the road network and generates traffic data reports from which the direction of traffic flow within a traffic lane may be determined. Additionally or alternatively, the traffic reporting devices may have a fixed location proximate a roadway and may monitor the traffic flow thereby from which a traffic data report may be generated. In an example embodiment, the traffic reporting device may be a proximity detector or series of proximity detectors which register a vehicle identifier at a specified location, from which traffic data may be interpolated and reported.

The reporting device 108 may provide traffic data to the traffic repository 106 periodically or upon request. The traffic data repository may receive and store traffic data from the traffic reporting devices 108 for future analysis. Additionally or alternatively, the traffic reporting device 108 may provide traffic data directly to the traffic server 102.

The traffic server may receive traffic data from the traffic repository 106 and/or the traffic reporting device 108. The traffic data may be provided by one or more traffic probes, such that the traffic data may be crowd sourced. A traffic probe be provide the traffic data of a single vehicle over a period of time. The traffic data may include location data, (e.g. longitude and latitude coordinate, proximity indicator, or other location indicator), speed data (e.g. miles per hour, kilometers per hour, or other relevant speed measurement), time data (e.g. timestamp of the measurements), direction data (e.g. heading or bearing of travel), vehicle identifier, or the like.

In an example embodiment a traffic probe may additionally or alternatively provide reports received from one or more proximity detectors at known locations which detect a vehicle identifier. The proximity detectors may be near field communication (NFC) detectors, radio frequency identification (RFID) detectors, symbol readers, or the like. The proximity detectors may report time stamped location data and vehicle identifier data from which a traffic reporting device 108 may interpolate the direction and/or speed data of the traffic. The traffic reporting device 108 may report the traffic data to the traffic data repository 106 or traffic server as discussed above.

The traffic server 102 may map the traffic data to a road network based on the location data to create a traffic data map. For example the location data may indicate measurements taken at various points along Interstate 95, or the Kennedy Expressway.

The traffic server 102 may determine the direction of travel for one or more road network lanes based on the traffic data map. In an example embodiment, the direction of travel may be determined by the direction data, such as heading or bearing associated with each mapped traffic data point. For example, one or more traffic data points may indicate that a vehicle is in the middle lane of 1-95 headed North. Additionally or alternatively, the traffic server 102 may determine the direction of travel based on multiple location data and associated time data points of the traffic data, for example two consecutive time data points with associated location data for the same vehicle may indicate that direction of travel from the first to the second location.

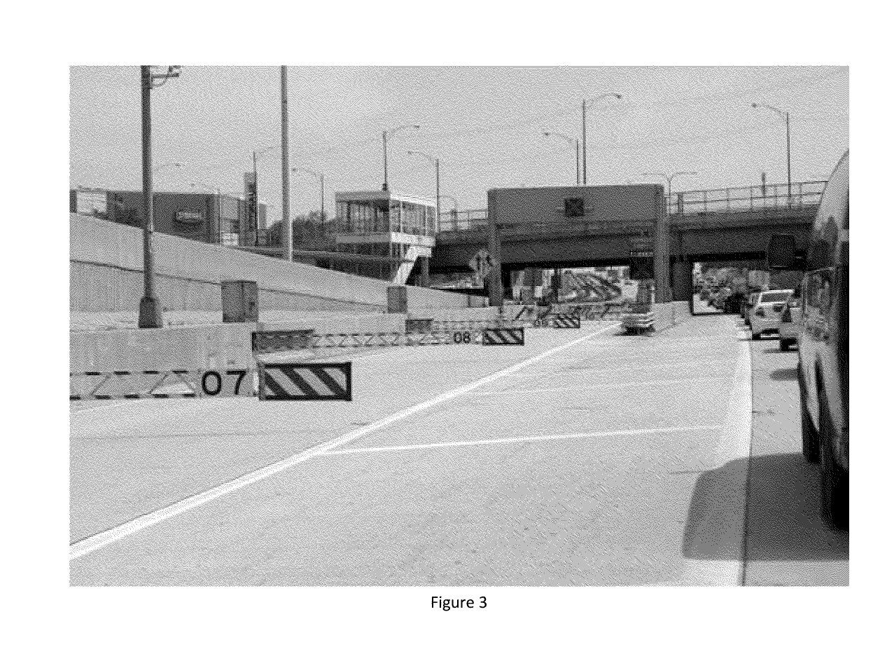

The traffic server 102 may determine if one or more road network lanes are reversible, e.g. change directions based on the direction of travel over a period of time. For example, if a road network lane is determined to have traffic data determined to have a northern direction of travel and traffic data determined to have a southern direction of travel, the road network lane may change directions. A photograph of an example reversible lane, e.g. the Kennedy Expressway, is depicted in FIG. 3.

In some example embodiments, the traffic server 102 may determine times at which the road network lanes change direction. In an instance in which the traffic server receives real time or near real time traffic data, the traffic server may determine real time changes in road network lane direction by comparing preceding traffic data direction of travel to current direction of travel. In an instance in which the traffic server receives historic traffic data, the traffic server may determine regular road network lane direction changes, such as daily rush hour changes in direction. The traffic server 102 may determine regular road network lane changes in direction by plotting the direction of travel for a road network lane over a predetermined period of time. The traffic server may segment the predetermined period of time into 60 minute, 30 minute, 15 minute, 5 minute, or other time intervals.

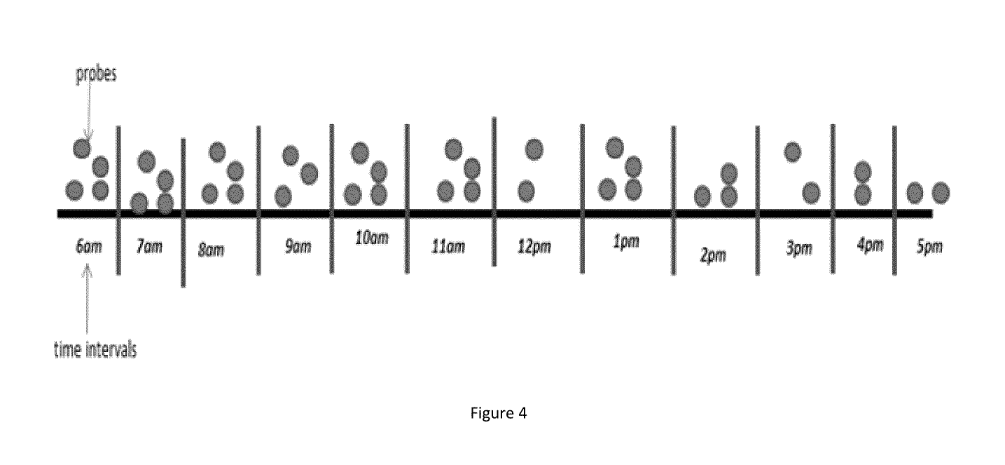

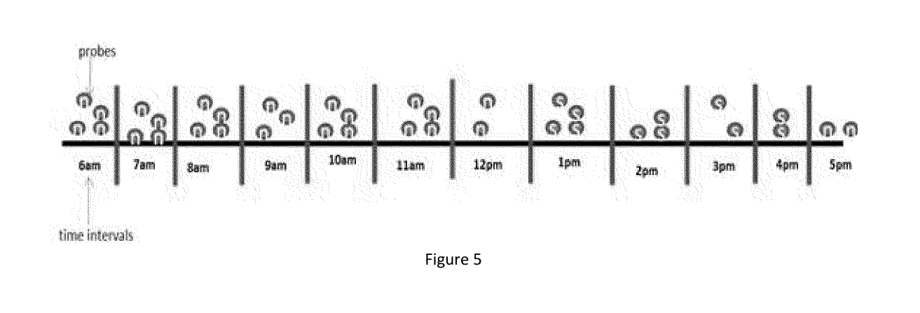

The traffic server 102 may determine the road network lane change of direction based on the time intervals at which the direction of travel changes, such as depicted in FIGS. 4 and 5. For example, if the predetermined period of time is 6 am to 5 pm and interval periods are 60 minutes, traffic data may be clustered into each interval based on time data associated with the traffic data, as depicted in FIG. 4. The traffic server 102 may determine the direction of travel for each traffic data point, e.g. North (n), South (s), or other navigational direction, as depicted in FIG. 5. The traffic server 102 may determine that a road network lane changes direction between 12 PM and 1 PM based on the change of direction between the 12 PM and 1 PM time interval. The smaller the interval period the more precise the time of change of direction may be. Additionally or alternatively, the traffic server 102 may adjust the time interval and reanalyze the traffic data for the interval in which the lane change occurs to determine a more accurate time. For example, the 12 PM to 1 PM interval may be evaluated with a smaller, e.g., a 5 minute, interval period.

Additionally or alternatively, the traffic server 102 may determine times at which the road network lanes change direction for different days of the week, such as weekdays and weekends. The traffic server 102 may analyze historic traffic data for a longer period, such as several weeks, to determine patterns of road network lane change of direction times. Some examples of regular road network lane change of directions may be associated with rush hour lanes, or event lanes.

In an example embodiment, the traffic server 102 may determine and suppress outlier traffic data. The traffic data may be compared to a predetermined threshold, such as speed, direction and location, or the like. In an instance in which the traffic data satisfies the predetermined threshold the traffic server may suppress the traffic data to avoid the direction of travel being determined based thereupon. Traffic data with unrealistic headings, speeds, locations, or the like, such as may be determined by headings, speeds or locations that fail to satisfy predefined criteria, may be pruned prior to analysis of the traffic data. In an example embodiment, the speed threshold may be 150 kilometers per hour (kph), in an instance in which the traffic data speed data satisfies the predetermined threshold, the speed may be determined to be unreasonably high and the associated traffic data suppressed. In another example, the predetermined threshold may be an area of interest. In an instance in which the traffic data location data is outside of the area of interest, the traffic data may be suppressed. In a further example, the predetermined threshold may be possible headings on a road network lane, such as North or South. In an instance in which the traffic data direction data indicates a heading of West or East, the traffic server 102 may suppress the traffic data, since such data may be from vehicles travelling perpendicular to the road network of interest, such as an intersecting road.

In some example embodiments, the traffic server 102 may determine the mode of transportation associated with the traffic data. In some example embodiments, the traffic server 102 may determine the mode of transportation based on a vehicle identifier. For example some traffic data may include a vehicle identifier which specifies the type of vehicle from which the traffic data is received, such as, transport truck, bus, car, Ford™ vehicle, Ford Focus™ car, or the like. Additionally, or alternatively, mode of travel may be determined using traffic data such as speed data, direction data, location data, or the like. For example, a vehicle traveling at 15 kph may be determined to be a bike. Buses may be identified based upon traffic data indicating bus stops, such as slow or stopped speed data at locations near bus stops at or near bus scheduled stops, and/or traveling a bus route as indicated by location and direction data. Transport trucks may be associated with traffic data indicating slower travel on road network lanes which have high speed limits, e.g. 100 kph or greater, or location data associated with shipping docks.

The traffic server 102 may suppress traffic data associated with predetermined mode of transportation to avoid the direction of travel being determined based thereupon. For example, the traffic server 102 may determine that bus and transport truck traffic data is irrelevant, contrary to normal traffic flows, has a lane use restriction, or the like. The traffic server 102 may discard the traffic data associated to transport trucks and buses.

The traffic server may use the times at which the road network lane changes direction in the generation or updating traffic routing instructions, such as global positioning system (GPS) directions for a driver. For example, the time of the road network lane change of direction may indicate more or less lanes of travel in a particular direction. The traffic server may account for the increase or decrease in traffic lanes in a certain direction in generating traffic routing instructions to minimize driving times or to otherwise satisfy a driver's requirements or preferences while taking into account the increase or decrease of traffic lanes in a certain direction. The traffic routing instructions may be transmitted to and displayed on a UE 104.

### Example Apparatus

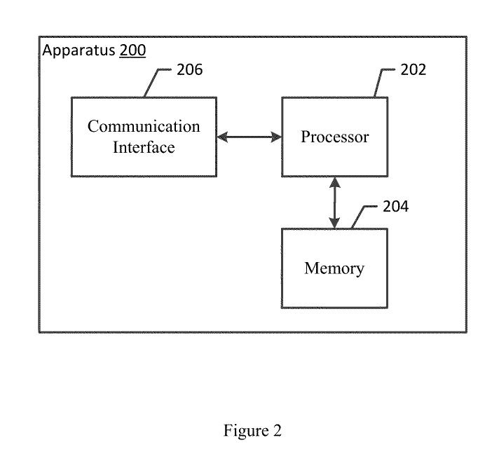

A traffic server 102 and/or a UE 104 may include or otherwise be associated with an apparatus 200 as shown in FIG. 2. The apparatus, such as that shown in FIG. 2, is specifically configured in accordance with an example embodiment of the present invention for determining road network lane directional changes. The apparatus may include or otherwise be in communication with a processor 202, a memory device 204, a communication interface 206, and a user interface 208. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (for example, a computer readable storage medium) comprising gates configured to store data (for example, bits) that may be retrievable by a machine (for example, a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As noted above, the apparatus 200 may be embodied by traffic server 102 and/or a UE 104. However, in some embodiments, the apparatus may be embodied as a chip or chip set. In other words, the apparatus may comprise one or more physical packages (for example, chips) including materials, components and/or wires on a structural assembly (for example, a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 202 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 202 may be configured to execute instructions stored in the memory device 204 or otherwise accessible to the processor. Alternatively or additionally, the processor may be configured to execute hard coded functionality. As such, whether configured by hardware or software methods, or by a combination thereof, the processor may represent an entity (for example, physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (for example, a mobile terminal or a fixed computing device) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The apparatus 200 of an example embodiment may also include a communication interface 206 that may be any means such as a device or circuitry embodied in either hardware or a combination of hardware and software that is configured to receive and/or transmit data from/to a communications device in communication with the apparatus, such as to facilitate communications with one or more user equipment 102, traffic data repositories 104, traffic reporting devices 108, or the like. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware and/or software for supporting communication via cable, digital subscriber line (DSL), universal serial bus (USB) or other mechanisms.

### Example Process for Determining Road Network Lane Directional Changes

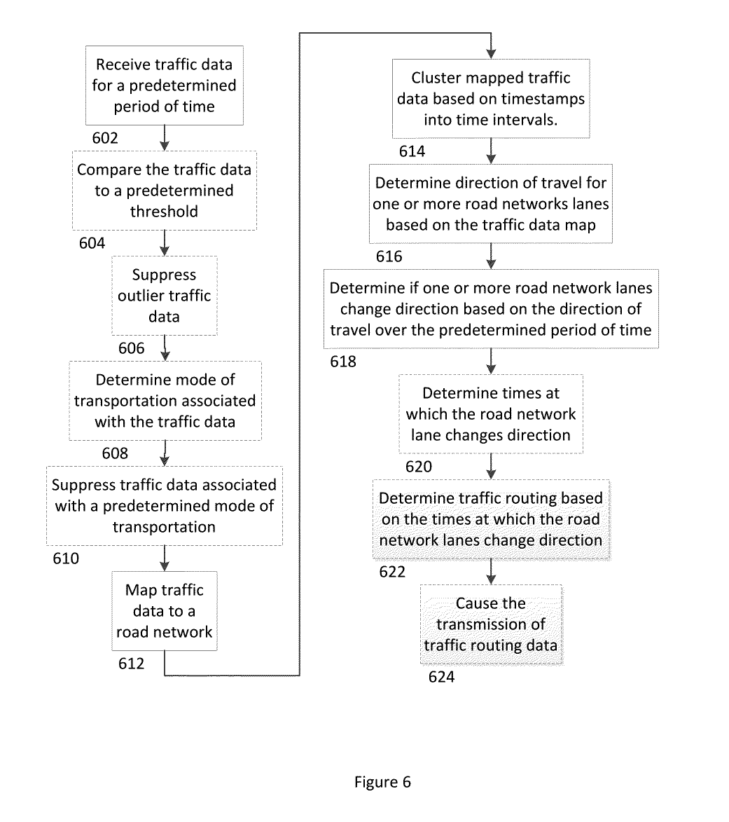

Referring now to FIG. 6, the operations performed, such as by the apparatus 200 of FIG. 2, for determining road network lane directional changes are depicted. As shown in block 602 of FIG. 6, the apparatus 200 may include means, such as a processor 202, a memory 204, a communications interface 206, or the like, configured to receive traffic data for a predetermined period of time. The processor 202 may receive the traffic data from the communications interface 206 which in turn may receive the traffic data from a memory 204, such as the traffic data repository 106 and/or a mobile device, such as traffic reporting device 108. The traffic data may include location data, (e.g. longitude and latitude coordinate, proximity indicator, or other location indicator), speed data (e.g. miles per hour, kilometers per hour or other relevant speed measurement), time data (e.g. timestamp of the measurements), direction data (e.g. heading or bearing of travel), vehicle identifiers, or the like.

In an example embodiment, the traffic data may be real time, near real time and/or historical data reports from a traffic reporting device 108 which has traversed a road network lane and/or captures traffic data associated with a road network lane, such as proximity detectors. Traffic data may be provided from other sources in other embodiments as noted above, such as GPS enabled probe vehicles or loop detector sensors.

As shown in block 604 of FIG. 6, the apparatus 200 may include means, such as a processor 202, or the like, configured to compare the traffic data to a predetermined threshold. The predetermined threshold may be a speed, direction location, or the like. The processor may compare the speed data, location data, direction data, or the like to the predetermined threshold.

As shown at block 606, of FIG. 6, the apparatus 200 may include means, such as a processor 202, or the like, configured to suppress outlier traffic data to avoid the direction of travel being determined based thereupon. The processor 202 may determine that traffic data which satisfies a predetermined threshold is irrelevant, or unreasonable. For example, speed data of greater than 150 kph, direction data which is perpendicular to the direction which the road network lanes of interest travel, location data outside the area of interest, or the like may be disregarded. The processor 202 may suppress, or discard, the location data which satisfies the predetermined threshold from further analysis.

As shown at block 608 of FIG. 6, the apparatus 200 may include means, such as a processor 202, or the like, configured to determine the mode of transportation associated with the traffic data. The processor 202 may determine the mode of transportation associated with the traffic data, based on vehicle identifiers, speed data, direction data, location data, or the like. The speed data, location data, direction data, or the like may be indicative of the mode of transportation such as a transportation truck, bus, bicycle, or the like.

As shown at block 610 of FIG. 6, the apparatus 200 may include means, such as a processor 202, or the like, configured to suppress traffic data associated with a predetermined mode of transportation to avoid the direction of travel being determined based thereupon. The processor 202 may determine that traffic data from predetermined modes of transportation are irrelevant, contrary to normal traffic patterns, or subject to lane usage restrictions, such as bicycles, busses, and/or transport trucks. The processor 202 may suppress, or discard, the traffic data associated with the predetermined mode of transport from further analysis.

As shown at block 612 of FIG. 6, the apparatus 200 may include means, such as a processor 202, or the like, configured to map the traffic data to a road network to create a traffic data map. The processor 202 may associate the location data with a road network or specific road network lanes and generate a map of traffic data over the road network. In an example embodiment, the processor 202 may utilize a map matching process. The map matching may associate traffic data with a particular road/lanes, since GPS have errors and the traffic data may not be aligned with the road network due to the inherent GPS errors

As shown at block 614 of FIG. 6, the apparatus 200 may include means, such as a processor 202, or the like, configured to cluster mapped traffic data based on time stamps into time intervals. The processor 202 may cluster the mapped traffic data based on time stamps into predetermined time intervals, such as 60 minutes, 30 minutes, 15 minutes, 5 minutes, or other time interval, as depicted in FIG. 4.

As shown at block 616 of FIG. 6, the apparatus 200 may include means, such as a processor 202, or the like, configured to determine direction of travel for one or more road network lanes based on the traffic map data. The processor 202 may determine the direction of travel based on direction data such as heading, bearing, or the like. Additionally or alternatively, the processor 202 may determine the direction of travel by comparing location data at a first time to a location data for the same vehicle at a second time and determining direction of travel based on the change in location data.

As shown at block 618 of FIG. 6, the apparatus 200 may include means, such as a processor 202, or the like, configured to determine if one or more road network lanes change direction based on the direction of travel over a period of time. The processor 202 may analyze the traffic data to determine if the direction of travel in a specified road network lane changes direction. For example, a road network lane may have a first direction of travel at a first time and a second direction of travel at a second time, such as North at 11:45 AM and South at 12:15 AM. In this example, the processor 202 may determine that the direction of travel has changed.

As shown at block 620 of FIG. 6, the apparatus 200 may include means, such as a processor 202, or the like, configured to determine times at which the road network lane changes direction. The processor 202 may determine that that the road network lane change occurred between the two traffic data times for which the direction data is different, e.g., North versus South. Continuing the example, the processor 202 may determine that the road network lane change occurred between 11:45 AM and 12:15 PM.

Additionally or alternatively, the processor 202 may determine regular road network lane direction changes based on historical traffic data, such as directional lane changes that occur on each day of the week, e.g. rush hour and/or event lanes on weekdays and weekends.

As shown at block 622 of FIG. 6, the apparatus 200 may include means, such as a processor 202, or the like, configured to determine a traffic route based on the times at which the road network lanes change direction. The processor 202 may determine a traffic route based on the regular road network lane change of direction, such as rush hour or event lanes. Additionally or alternatively, the processor may update traffic routing based on the real time road network lane change of direction.

As shown at block 624 of FIG. 6, the apparatus 200 may include means, such as a processor 202, communications interface 206, or the like, configured to cause the transmission of traffic routing data. The processor 202 may cause the communications interface 206 to transmit the traffic routing instructions or traffic routing instruction updates to a UE 104. The UE 104 may receive and display the traffic routing instructions on a user interface.

The reversible lane data may allow for the generation of more accurate traffic routing instructions for users. The higher accuracy routing data may ensure that the user is routed in the correct direction on reversible lanes.

Additionally, real time or near real time determinations of revisable lanes changing direction may also allow for generation or updates to traffic routing instructions to minimize drive times or otherwise satisfy user requirements or preferences.

As described above, FIG. 6 illustrates a flowchart of an apparatus 200, method, and computer program product according to example embodiments of the invention. It will be understood that each block of the flowchart, and combinations of blocks in the flowchart, may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 204 of an apparatus employing an embodiment of the present invention and executed by a processor 202 of the apparatus. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included, such as illustrated by the dashed outline of blocks 604, 606, 608, 610, 620, 622, and 624 in FIG. 6. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
receiving traffic data for a predetermined period of time;
mapping the traffic data to a road network to create a traffic data map;
determining a direction of travel for one or more road network lanes based on the traffic data map; and
determining, using a processor, if the one or more road network lanes change direction based on the direction of travel over the predetermined period of time.

2. The method of claim 1 further comprising:
suppressing outlier traffic data to avoid the direction of travel being determined based thereupon.

3. The method of claim 2, wherein suppressing outlier traffic data further comprises comparing the traffic data to a predetermined threshold and suppressing traffic data which satisfies the predetermined threshold.

4. The method of claim 1 further comprising:
determining a mode of transportation associated with the traffic data; and
suppressing traffic data associated with a predetermined mode of transportation to avoid the direction of travel being determined based thereupon.

5. The method of claim 1 further comprising:
determining the times at which the one or more road network lanes change direction.

6. The method of claim 1, wherein the traffic data comprises location data, direction data, speed data, and time data.

7. The method of claim 1 further comprising:
clustering the mapped traffic data based on timestamps into a plurality of time intervals; and
wherein the determining if one or more road network lanes change direction is further based on the clustered mapped traffic data.

8. An apparatus comprising at least one processor and at least one memory including computer program code, the at least one memory and computer program code configured to, with the processor, cause the apparatus to at least:
receive traffic data for a predetermined period of time;
map the traffic data to a road network to create a traffic data map;
determine a direction of travel for one or more road network lanes based on the traffic data map; and
determine if the one or more road network lanes change direction based on the direction of travel over the predetermined period of time.

9. The apparatus of claim 8, wherein the at least one memory and the computer program code are further configured to:
suppress outlier traffic data to avoid the direction of travel being determined based thereupon.

10. The apparatus of claim 9, wherein suppressing outlier traffic data further comprises comparing the traffic data to a predetermined threshold and suppressing traffic data which satisfies the predetermined threshold.

11. The apparatus of claim 8, wherein the at least one memory and the computer program code are further configured to:
determine a mode of transportation associated with the traffic data; and
suppress traffic data associated with a predetermined mode of transportation to avoid the direction of travel being determined based thereupon.

12. The apparatus of claim 8, wherein the at least one memory and the computer program code are further configured to:
determine the times at which the one or more road network lanes change direction.

13. The apparatus of claim 8, wherein the traffic data comprises location data, direction data, speed data, and time data.

14. The apparatus of claim 8, wherein the at least one memory and the computer program code are further configured to:
cluster the mapped traffic data based on timestamps into a plurality of time intervals; and
wherein the determining if one or more road network lanes change direction is further based on the clustered mapped traffic data.

15. A computer program product comprising at least one non-transitory computer-readable storage medium having computer-executable program code portions stored therein, the computer-executable program code portions comprising program code instructions configured to:
receive traffic data for a predetermined period of time;
map the traffic data to a road network to create a traffic data map;
determine a direction of travel for one or more road network lanes based on the traffic data map; and
determine if the one or more road network lanes change direction based on the direction of travel over the predetermined period of time.

16. The computer program product of claim 15, wherein the computer-executable program code portions further comprise program code instructions configured to:
suppress outlier traffic data to avoid the direction of travel being determined based thereupon.

17. The computer program product of claim 16, wherein suppressing outlier traffic data further comprises comparing the traffic data to a predetermined threshold and suppressing traffic data which satisfies the predetermined threshold.

18. The computer program product of claim 15, wherein the computer-executable program code portions further comprise program code instructions configured to:
determine a mode of transportation associated with the traffic data; and
suppress traffic data associated with a predetermined mode of transportation to avoid the direction of travel being determined based thereupon.

19. The computer program product of claim 15, wherein the computer-executable program code portions further comprise program code instructions configured to:
determine the times at which the one or more road network lanes change direction.

20. The computer program product of claim 15, wherein the computer-executable program code portions further comprise program code instructions configured to:
cluster the mapped traffic data based on timestamps into a plurality of time intervals; and
wherein the determining if one or more road network lanes change direction is further based on the clustered mapped traffic data.

21-28. (canceled)
